(19) United States
(12) Patent Application Publication
(10) Pub. No.: US 2012/0075353 A1
(43) Pub. Date: Mar. 29, 2012

(54) System and Method for Providing Control Data for Dynamically Adjusting Lighting and Adjusting Video Pixel Data for a Display to Substantially Maintain Image Display Quality While Reducing Power Consumption

(75) Inventors: Hongfeng Dong, Markham (CA); Stephen Bagshaw, Markham (CA); Don Cherepacha, Oakville (CA); David Glen, Toronto (CA)

(73) Assignee: ATI Technologies ULC, Markham (CA)

(21) Appl. No.: 12/891,442

(22) Filed: Sep. 27, 2010

(51) Int. Cl. G09G 5/10; G06K 9/00

(52) U.S. Cl. 345/690; 382/168

(57) ABSTRACT

System and method for providing control data for dynamically adjusting lighting and adjusting video pixel data for a display to substantially maintain image display quality while reducing power consumption. In accordance with one or more embodiments, image statistics, e.g., histogram data representing luma values corresponding to pixels for a video frame, are analyzed to determine whether the pixels represent one or more of a plurality of images which includes an image containing primarily natural imagery, an image containing primarily graphics imagery, and an image containing a combination of at least respective portions of natural and graphics imagery. Based on such analysis, control data are provided to enable light source brightness reduction by one of a plurality of percentages and pixel brightness increases, e.g., in accordance with one of a plurality of multiple-segment piecewise linear curves defined in accordance with respective segment slopes, thresholds, and threshold offsets in accordance with whether the incoming pixel data primarily represents a natural image, primarily represents a graphics image, or represents a combination of natural and graphics images.

### FIELD OF THE DISCLOSURE

The present disclosure relates to brightness controls for video displays, and in particular, to controlling brightness of displays and for projectors.

### BACKGROUND OF THE DISCLOSURE

Currently, displays, such as liquid crystal display (LCD) panels, use backlighting to illuminate the display from the side or back of the display panel. Backlighting in displays uses significant amounts of power, particularly in relation to other portions of the system, such as a laptop computer system within which the display panel is incorporated. A user typically sets the backlight brightness level for their display that suits the environment and the type of content being viewed. For example, in a darkened room, the user will typically set the backlight to a low brightness level, while, conversely, in a bright environment, such as outdoors or a bright office environment, the user will typically set the backlight to a high brightness level. When using graphics applications, e.g., a computer application such as spreadsheet or word processing programs, a graphical user interface or a non-photo realistic computer generated image, that have a bright white background with black lettering, the user will typically set the backlight to a higher brightness level to make it easier to read the black letters on the bright white background. However, when watching a movie, which typically contains much larger black areas and fewer areas of bright color, the user may wish to set the backlight to a lower brightness level to obtain deeper black levels and better contrast.

Current solutions for reducing power consumption include the user manually adjusting the backlight settings. Other techniques involve systems using software or hardware or a combination of hardware and software to control the backlight settings. However, such systems, similar to manual adjustments, result in decreased contrast ratios resulting from a decrease in the dynamic range of the pixel values with the reduced backlighting. Still other solutions have used statistical data about the image to apply a single correction function independent of the type or classification of its content.

Accordingly, it would be desirable to have an automated system and method for adaptively modulating backlight brightness while maintaining contrast ratios.

### BRIEF DESCRIPTION OF THE DRAWINGS

FIG. 1 is a functional block diagram depicting a system for dynamically adjusting backlighting brightness and video pixel brightness in accordance with one embodiment.

FIGS. 2 and 3 depict output versus input graphs for backlighting brightness and pixel brightness, respectively, when dynamically adjusting backlighting brightness and video pixel brightness in accordance with exemplary embodiments.

FIGS. 4 and 5 are examples of histograms for pixel data generated in accordance with exemplary embodiments.

FIG. 6 is a flowchart depicting pixel data analysis and adjustment in accordance with another embodiment.

FIG. 7 is a flowchart depicting backlighting and pixel brightness adjustment in accordance with another embodiment.

### DETAILED DESCRIPTION OF THE PREFERRED EMBODIMENTS

System and method for providing control data for dynamically adjusting backlighting and adjusting video pixel data for a display to substantially maintain image display quality while reducing power consumption. In accordance with one or more embodiments, histogram data representing luma values corresponding to pixels for the image within a video frame are analyzed to determine whether the pixels represent one or more of a plurality of images which includes an image containing primarily video data, an image containing primarily graphics data, and an image containing a combination of at least respective portions of video and graphics data. Based on such analysis, control data are provided to enable backlight brightness adjustment and pixel brightness increases, e.g., in accordance with one of a plurality of multiple-segment piecewise linear curves defined in accordance with respective segment slopes, thresholds, and threshold offsets in accordance with whether said incoming pixel data primarily represents a video image, primarily represents a graphics image, or represents a combination of video and graphics images.

Advantageously, the system and method disclosed herein reduce power consumption without requiring the user to manually adjust light source settings. A further, or alternative, advantage is an automated system and method for adaptively modulating light source brightness while maintaining or increasing contrast ratios.

Further advantageously, the system and method disclosed herein use image statistics, e.g., image histogram statistics, to classify the image content, and based on such classification, apply different correction algorithms.

In accordance with one embodiment, a method includes: determining whether a plurality of pixels represents one or more of a plurality of images which includes an image containing primarily video data, an image containing primarily graphics data, and an image containing a combination of at least respective portions of video and graphics data, based on data representing a plurality of pixel luma values corresponding to the plurality of pixels; and generating control data for adjusting backlight brightness for the display and adjusting the incoming pixel brightness for display on the display, wherein the backlight brightness is reduced by one of a plurality of percentages and the pixel luma values are increased in accordance with one of a plurality of multiple-segment piecewise linear curves defined in accordance with respective segment slopes, thresholds, and threshold offsets in accordance with whether the incoming pixel data primarily represents a video image, primarily represents a graphics image, or represents a combination of video and graphics images.

In accordance with another embodiment, an apparatus including circuitry includes adaptive contrast enhancement circuitry for: determining whether a plurality of pixels represents one or more of a plurality of images which includes an image containing primarily video data, an image containing primarily graphics data, and an image containing a combination of at least respective portions of video and graphics data, based on data representing a plurality of pixel luma values corresponding to the plurality of pixels, and generating control data for adjusting backlight brightness for the display and adjusting the incoming pixel brightness for display on the display, wherein the backlight brightness is reduced by one of a plurality of percentages and the pixel luma values are increased in accordance with one of a plurality of multiple-segment piecewise linear curves defined in accordance with respective segment slopes, thresholds, and threshold offsets in accordance with whether the incoming pixel data primarily represents a video image, primarily represents a graphics image, or represents a combination of video and graphics images.

In accordance with another embodiment, an apparatus includes memory capable of storing executable instructions, and at least a first processor operably coupled to the memory. The first processor is responsive to the executable instructions by: determining whether a plurality of pixels represents one or more of a plurality of images which includes an image containing primarily video data, an image containing primarily graphics data, and an image containing a combination of at least respective portions of video and graphics data, based on data representing a plurality of pixel luma values corresponding to the plurality of pixels; and generating control data for adjusting backlight brightness for the display and adjusting the incoming pixel brightness for display on the display, wherein the backlight brightness is reduced by one of a plurality of percentages and the pixel luma values are increased in accordance with one of a plurality of multiple-segment piecewise linear curves defined in accordance with respective segment slopes, thresholds, and threshold offsets in accordance with whether the incoming pixel data primarily represents a video image, primarily represents a graphics image, or represents a combination of video and graphics images.

The following detailed description is of example embodiments of the presently disclosed subject matter with references to the accompanying drawings. Such description is intended to be illustrative and not limiting with respect to the scope of the presently disclosed subject matter. Such embodiments are described in sufficient detail to enable one of ordinary skill in the art to practice the disclosed subject matter, and it will be understood that other embodiments may be practiced with some variations without departing from the spirit or scope.

Throughout the present disclosure, absent a clear indication to the contrary from the context, it will be understood that individual circuit elements as described may be singular or plural in number. For example, the terms “circuit” and “circuitry” may include either a single component or a plurality of components, which are either active and/or passive and are connected or otherwise coupled together (e.g., as one or more integrated circuit chips) to provide the described function. Additionally, the term “signal” may refer to one or more currents, one or more voltages, or a data signal. Within the drawings, like or related elements will have like or related alpha, numeric or alphanumeric designators. Further, while the presently disclosed subject matter has been discussed in the context of implementations using discrete electronic circuitry (preferably in the form of one or more integrated circuit chips), the functions of any part of such circuitry may alternatively be implemented using one or more appropriately programmed processors, depending upon the signal frequencies or data rates to be processed. Moreover, to the extent that the figures illustrate diagrams of the functional blocks of various embodiments, the functional blocks are not necessarily indicative of the division between hardware circuitry. Thus, for example, one or more of the functional blocks (e.g., processors, memories, etc.) may be implemented in a single piece of hardware (e.g., a general purpose signal processor, random access memory, hard disk drive, etc.). Similarly, any programs described may be standalone programs, may be incorporated as subroutines in an operating system, may be functions in an installed software package, etc.

As is well known in the art, a system such as that disclosed herein is suitable for incorporation into or use with many types of higher level apparatuses having displays, including, but not limited to, computer systems, handheld devices, high definition televisions (e.g., capable of accepting computer signals for use as a computer monitor), or other suitable electronic systems.

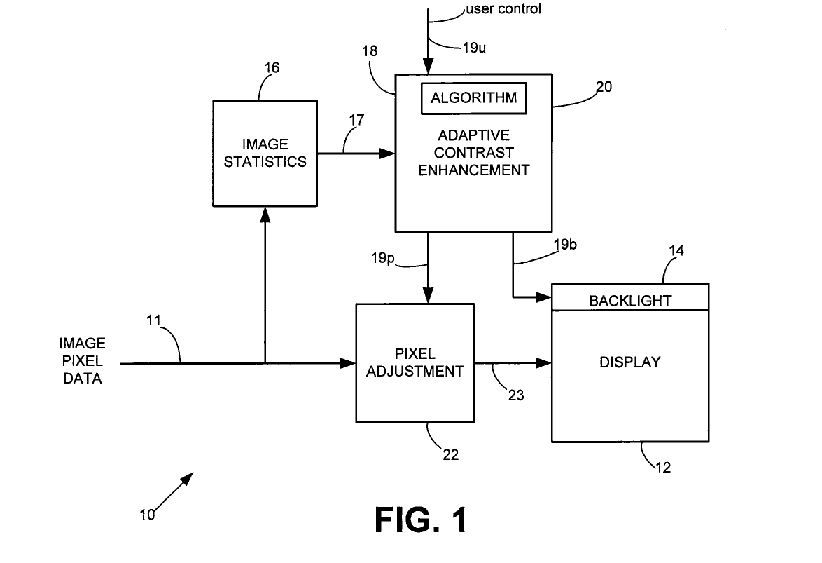

Referring to FIG. 1, one implementation 10 of a system having a display 12 for which its backlight 14 and pixel data are to be adjusted in accordance with one embodiment includes an image statistics generator 16, an adaptive contrast enhancement controller 18 and a pixel adjustment 22, interconnected substantially as shown. Image pixel data 11 for a video frame is received by the image statistics generator 16 and pixel adjustment 22. The image statistics generator 16 generates image statistics (e.g., histogram and luma) data 17 (discussed in more detail below) for processing by the adaptive contrast enhancement controller 18 in accordance with an algorithm 20, which can be hardwired circuitry or stored as firmware either within or otherwise available to the adaptive contrast enhancement controller 20, e.g., via one or more data buses or a network.

Based on these image statistics data 17 and the instructions of the algorithm 20, the adaptive contrast enhancement controller 18 generates backlight control data 19b for adjusting the brightness of the backlight 14 for the display 12, and pixel control data 19p for modifying the original incoming image pixel data 11 to provide adjusted image pixel data 23 (discussed in more detail below) for the display 12.

Alternatively, user control data 19u, e.g., based upon some a priori knowledge about the desired display characteristics, instead of the image statistics data 17, can be used by the adaptive contrast enhancement controller 18 to generate the backlight control data 19b and pixel control data 19p.

As discussed in more detail below, adaptive backlight modulation in accordance with one embodiment reduces power consumption in display devices by doing two things. First, it reduces the brightness of the backlight in the display, e.g., over time, from the user-selected backlight brightness level to a lower level based on the algorithm 20. Second, it compensates for this reduced backlight brightness by increasing the brightness of the pixels on the display.

Such adaptive backlight modulation preferably sets the maximum permitted backlight brightness level to be the backlight brightness level set by the user. It then analyses the image content of each frame, using a histogram, and calculates what the minimum acceptable backlight brightness level can be and designates this as the target backlight brightness level. This target backlight brightness level can change every frame if the image content varies significantly from one frame to the next. Over a period of time, the current backlight brightness level is changed to move towards this target backlight brightness level until it is reached. Since the change in backlight brightness is done over time, and compensated for at the same rate by adjusting pixel brightness using a contrast adjustment function discussed in more detail below), the change in backlight brightness (typically reduction) is barely perceptible to the end user.

Such adaptive backlight modulation can support modifying one backlight and the associated pixel data for each display controller using a single processor, e.g., to do post-processing, calculations, and register programming.

The image statistics generator 16 determines brightness distribution of pixels in a frame of the incoming image pixel data. The granularity of computation depends on how many pixel values are grouped in each bin, e.g., more bins mean a more accurate histogram. This statistical data then can be used to analyze the overall brightness of pixels in a frame. The image statistics generator 16 is implemented to operate using a selectable number of bins, e.g., a minimum of eight and a maximum of 32 bins. In accordance with an exemplary embodiment, there are three possible bin sizes of 8, 16 and 32 available to collect pixel values in the range of 0-1023.

The image statistics generator 16 further provides statistical information on the pixel data in a frame. The statistical information includes sums of pixels, pixel minimums, pixel maximums, filtered pixel minimums, filtered pixel maximums, and pixel counts of pixels below minimum pixel value thresholds and above maximum pixel value thresholds. Additionally, the image statistics generator 16 provides statistical information on the frame of video data, including: sums of total pixels in the active region of the raster; sums of luma, red, green and blue color components of the data; minimums and average minimums for luma, red, green and blue color components in the active region of the raster; maximums and average maximums for luma, red, green and blue color components in the active region of the raster; and counts of pixels below set thresholds for minimum and maximum pixel values where value R=value G=value B.

The adaptive contrast enhancement controller 18 implements the backlight 14 reduction while improving the contrast of an image by remapping the set of pixel values that are used in the image to span over all available pixel values that the display 12 can handle. This is important for LCD and plasma displays that have limited dynamic range and therefore poorer contrast. As discussed in more detail below, the adaptive contrast enhancement controller 18 implements a fully programmable multiple-segment piece-wise linear curve defined by multiple programmable threshold settings, thereby allowing the user to define a minimum, maximum and other ranges of interest for an input signal.

The pixel adjustment 22, in response to the pixel brightness control data 19p, generates new values of red, green and blue color components from the original red, green and blue color components of the original image pixel data 11, based on the histogram of the image and application of the algorithm 20. Such adjustments to the color components can be either additive in the form of ΔY or multiplicative in the form of a K-factor. For example, in one mode respective pixel based scalar values K1, K2, K3 are multiplied with each of the three color components after which the product is added with a respective offset, in another mode a pixel based scalar value ΔY is added to the original R, G and B components, and in another mode a pixel based scalar value K is multiplied with each of the three color components, as follows:

Mode 1: R′=K1*R+OFFSET1
G′=K2*G+OFFSET2
B′=K3*B+OFFSET3

Mode 2: R′=ΔY+R
G′=ΔY+G
B′=ΔY+B
Y=luma of original pixel based on R, G and B component values
Y′=luma of new pixel after adjustment
ΔY=Y′−Y
Y′=mY+b
so ΔY=Y′−Y=(mY+b)−Y=(m−1)Y+b

Mode 3: R′=kR
G′=kG
B′=kB
V=maximum color component value of R, G and B component values of original pixel
V′=maximum color component value after adjustment
K=V′/V
V′=mV+b
So K=(mV+b)/V=m+b/V

The goal of such adaptive backlight modulation is to ensure that the combination of the brighter pixels and reduced backlight brightness produces an image that is virtually identical (in terms of brightness, contrast, and color fidelity) to the original image that used the brighter backlight, while reducing power consumption due to the lower backlight power corresponding to the lower backlight brightness level.

The image statistics generator 16 generates a histogram with a programmable number of bins of the distribution of pixel values within the active display area. The histogram can collect brightness (luma (Y) values, or the maximum color component (V) value for each pixel. The maximum color component V is obtained by comparing the pixel intensity of the red, green, and blue color components and choosing the largest intensity value.

The image statistics generator 16 also determines the minimum and maximum pixel values for the red, green, and blue color components for all pixels within the active display. For each pixel, the red, green, and blue color components will be compared separately to an internally stored value that tracks the minimum and maximum values for each color component. If the current pixel color component value is smaller than the minimum for that color component, then it becomes the new minimum; if it is larger than the maximum for that color component, then it becomes the new maximum

The image statistics generator 16 also determines the minimum and maximum “filtered” pixel values for the red, green, and blue color components for all pixels within the active display, where “filtered” indicates that the red, green, and blue color component values of the current pixel are combined with the same color component values of the horizontally previous and horizontally next pixels and combined in a proportion of 1:2:1 (sum of horizontally previous pixel color component+twice the current pixel color component+horizontally next pixel color component), and then divided by 4 to yield the “filtered” value. This filtering is to done to minimize effects of isolated pixels (i.e., local maxima, local minima, overshoot and undershoot) with high pixel component color values.

The image statistics generator 16 also provides a count of the total number of pixels analyzed during the active display of the current frame, and counts the sum of all luma pixels in the active display. This can be used in combination with the total pixel count to determine average luma value.

The image statistics generator 16 also counts the sum of the red component of all pixels in the active display for calculating average red values. The image statistics generator 16 also counts the respective sums of the green and blue components of all pixels in the active display.

The image statistics generator 16 also provides a count of the number of white pixels (pixels with the same value for the red, green, and blue color components) with pixel values above a certain specified white pixel value threshold to enable determining when the majority of the screen's pixels are white. The image statistics generator 16 also provides a count of the number of black pixels (pixels with the same value for the red, green, and blue color components) with pixel values below a certain specified black pixel value threshold.

The adaptive contrast enhancement controller 18, in accordance with the algorithm 20, will use this histogram, luma, and maximum color value information 17 to calculate a target backlight brightness for maximizing power savings (within defined limits). The target backlight brightness level will not be set larger (brighter) than the backlight brightness level set by the user for the backlit display, nor set lower than a predefined minimum backlight brightness level. For example, this minimum backlight brightness level will be set based on a fixed percentage reduction (e.g., 15 or 20%) from the user specified initial backlight brightness level. The user-specified initial backlight brightness level is preferably treated as the maximum permitted backlight brightness level.

The adaptive contrast enhancement controller 18, in accordance with the algorithm 20, will then compare the current programmed backlight brightness level to the calculated target backlight brightness level. A preset backlight level update interval that specifies how often, e.g., in real time or frame times, that the backlight level value will be modified by the algorithm is used in these calculations. A preset backlight level increment step size that specifies how much to increase or decrease the backlight level at each update interval is also used in the calculations. Each time this backlight level update interval (in frames) elapses, the algorithm 20 compares the target backlight brightness level with the current backlight brightness level. The goal of the adaptive backlight modulation is to make the current backlight level equal the target backlight level, by transitioning, e.g., over time, the current backlight level towards the target backlight level. To achieve this, the algorithm 20 can choose among four actions: (1) increase the current backlight level by the predefined increment step size, (2) decrease the current backlight level by an equal step size, (3) make the current backlight level equal to the target backlight level if the difference is smaller than the increment step size, or (4) leave the current backlight level unchanged if it already is equal to the target backlight level.

The adaptive contrast enhancement controller 18, in accordance with the algorithm 20, takes this “next backlight brightness level” and multiplies it with an “ambient light” adjustment factor (a value ranging from zero to unity obtained from an external ambient light sensor), which is read by the algorithm 20 from elsewhere within the system 10, to determine the “next backlight level”, backlight adjustment 19b, to set in the backlight controller 14 associated with the display 12.

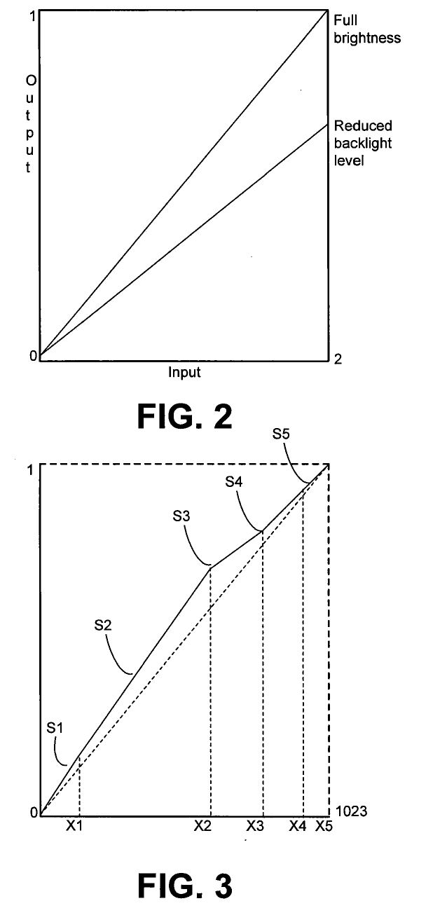

Referring to FIGS. 2 and 3, the adaptive contrast enhancement controller 18, in accordance with the algorithm 20, uses this data 17 (histogram data in combination with the maximum red, green, and blue color values, and the proposed next backlight brightness level), to determine the parameters for an optimal five-segment piecewise luma adjustment curve that will be applied to the pixel data 23 going to the display 12 during the next frame time. The goal of the pixel data brightness adjustment curve is to brighten the pixel data such that the combination of the adjusted (brightened) pixel data in combination with the reduced backlight brightness level equals the brightness of the unmodified pixel data at the original higher backlight brightness level. Another goal is to minimize the amount of color distortion caused by application of this pixel brightness adjustment curve. The pixel data brightness adjustment curve is applied equally to the red, green, and blue color components of each pixel. Color distortion typically occurs when one pixel has red, green, and/or blue color component values that fall within different segments of the brightness adjustment curve and thus all 3 color components are not equally adjusted causing the resultant pixel color to be different (distorted) from the original pixel because the relative proportions of the color components have changed. The amount of color distortion depends on the slope difference between the different segments of the brightness adjustment curve where the color component values fall.

The brightness adjustment curve operates in luma space and consists of five programmable segments. The starting luma value of the first segment S1 is fixed at zero. The ending luma value of the last segment S5 is fixed at 1023 (maximum 10-bit luma value). The remaining segments S2, S3, S4 can be positioned anywhere between zero and 1023. This results in a total of four programmable segment start/end positions (“thresholds” X1, X2, X3, X4). For each of these five segments, an offset, the vertical offset value at the beginning of each segment, and a slope can be programmed.

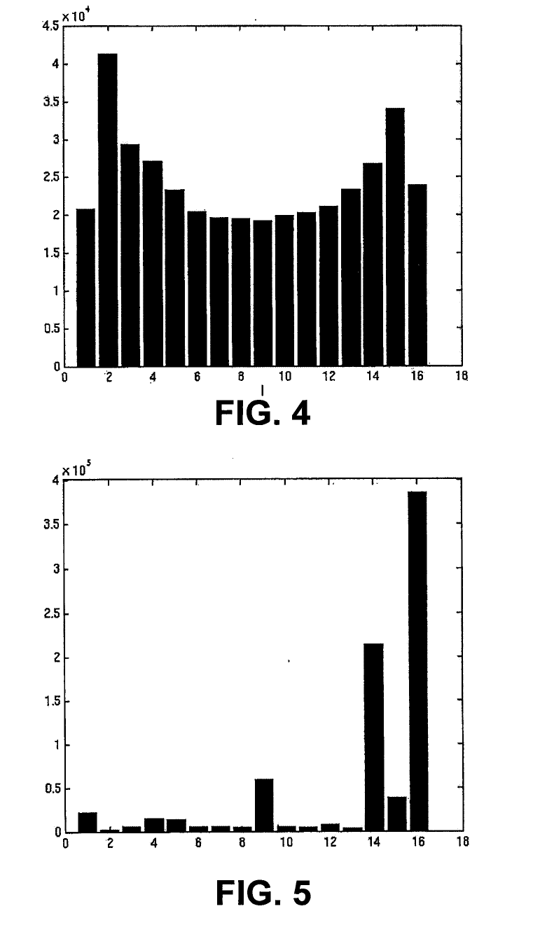

Referring to FIG. 4, when image data 11 is received representing a natural image, e.g., a video frame, a photograph, or three-dimensional graphics (as opposed to two-dimensional graphics), the image statistics generator 16 generates a histogram similar to that depicted. In accordance with an exemplary embodiment, the adaptive contrast enhancement controller 18 analyzes the data by adding the number of pixels collected in each of bins 3 through 14, and then dividing by the total number of pixels in the frame analyzed. If the resulting dividend is greater than 0.6, i.e., greater than 60 percent, there is no peak in the top two bins (bins 15 and 16), and bins 4 through 10 do not constitute less than one percent of the total number pixels, then the image pixel data 11 is deemed to represent a natural image.

In accordance with an exemplary embodiment, the thresholds (FIG. 3) are set as X1=64, X2=704, X3=832, X4=896 and X5=1023 on the pixel brightness (luma) input scale (i.e., x-axis) of 0-1023 (i.e., a scale from dark to bright). Additional parameters are established as follows:

P1=64, P2=560; PK1=0.25, PK3=0.4, PK4=0.1, PK5=−0.125; SHT=0

K1=1.0+percentage reduction*PK1

OFFSET1=0−SHT

K2=[1023−(1−percentage reduction)*(1023−P2)−P1]/(P2−P1)

OFFSET2=[(K1*X1+OFFSET1)−(K2*X1)]*(1−percentage reduction)

K3=1.0+percentage reduction*PK3

OFFSET3=[(K2*X2+OFFSET2)−(K3*X2)]*(1−percentage reduction)

K4=1.0+percentage reduction*PK4

OFFSET4=[(K3*X3+OFFSET3)−(K4*X3)]*(1−percentage reduction)

K5=1.0+percentage reduction*PK5

OFFSET5=[(K4*X4+OFFSET4)−(K5*X4)]*(1−percentage reduction)

For the first segment S1, the value on the curve is represented by the formula y=mx+b, where m=K1 and b=OFFSET1. Similarly, for the second segment S2, the value on the curve is represented by the formula y=mx+b, where m=1(2 and b=OFFSET2. The third S3, fourth S4 and fifth S5 segments follow similarly, using parameters K3, K4 and K5, and OFFSET3, OFFSET4 and OFFSET5, respectively. The only special case is that the fifth segment S5 extends from position X4 up through the last value on the x-axis, which for this example is 1023.

Referring to FIG. 5, when image data 11 is received representing a graphics frame, i.e., not a natural image, the image statistics generator 16 generates a histogram similar to that depicted. In accordance with an exemplary embodiment, the adaptive contrast enhancement controller 18 analyzes the data as before by checking the percentage of pixels occupying bins 3 through 14, checking for peaks in the top two bins, and checking the percentage of pixels occupying bins 4 through 10. If the percentage of pixels occupying bins 3 through 14 is not greater than 60, and if there is a peak in one of the top two bins, and if the percentage of pixels occupying bins 4 through 10 is less than one, then the image pixel data 11 is deemed to represent a graphics picture.

In accordance with an exemplary embodiment, the thresholds (FIG. 3) are set as X1=128, X2=768, X3=832, X4=896 and X5=1023. The additional parameters are established as follows:

P1=128, P2=704; PK1=0.5, PK3=0.4, PK4=0.1, PK5=−0.125; SHT=4

K1=1+percentage reduction*PK1

OFFSET1=0−SHT

K2=[1023−(1−percentage reduction)*(1023−P2)−P1]/(P2−P1)

OFFSET2=[(K1*X1+OFFSET1)−(K2*X1)]*(1−percentage reduction)

K3=1+percentage reduction*PK3

OFFSET3=[(K2*X2+OFFSET2)−(K3*X2)]*(1−percentage reduction)

K4=1+percentage reduction*PK4

OFFSET4=[(K3*X3+OFFSET3)−(K4*X3)]*(1−percentage reduction)

K5=1+percentage reduction*PK5

OFFSET5=[(K4*X4+OFFSET4)−(K5*X4)]*(1−percentage reduction)

The formulae for mapping these to the five segments are as described above for the natural image case.

If the combination of the conditions described above (the percentage of pixels occupying bins 3 through 14 is/not greater than 60, there is/not a peak in one of the top two bins, and if the percentage of pixels occupying bins 4 through 10 is less/greater than one), differs from those described above for the natural image and graphics (two-dimensional) cases, then the image pixel data 11 is deemed to represent a combination natural image and graphics picture.

In accordance with an exemplary embodiment, the thresholds (FIG. 3) are set as X1=64, X2=704, X3=832, X4=896 and X5=1023. The additional parameters are established as follows:

P1=80, P2=608; PK1=0.25, PK3=0.4, PK4=0.1, PK5=−0.125; SHT=0

K1=1+percentage reduction*PK1

OFFSET1=O−SHT

K2=[1023−(1−percentage reduction)*(1023−P2)−P1]/(P2−P1)

OFFSET2=[(K1*X1+OFFSET1)−(K2*X1)]*(1−percentage reduction)

K3=1+percentage reduction*PK3

OFFSET3=[(K2*X2+OFFSET2)−(K3*X2)]*(1−percentage reduction)

K4=1+percentage reduction*PK4

OFFSET4=[(K3*X3+OFFSET3)−(K4*X3)]*(1−percentage reduction)

K5=1+percentage reduction*PK5

OFFSET5=[(K4*X4+OFFSET4)−(K5*X4)]*(1−percentage reduction)

It will be readily appreciated by one of ordinary skill in the art these values and parameters as used in the above examples are merely exemplary and can be modified as necessary to achieve a desired image display.

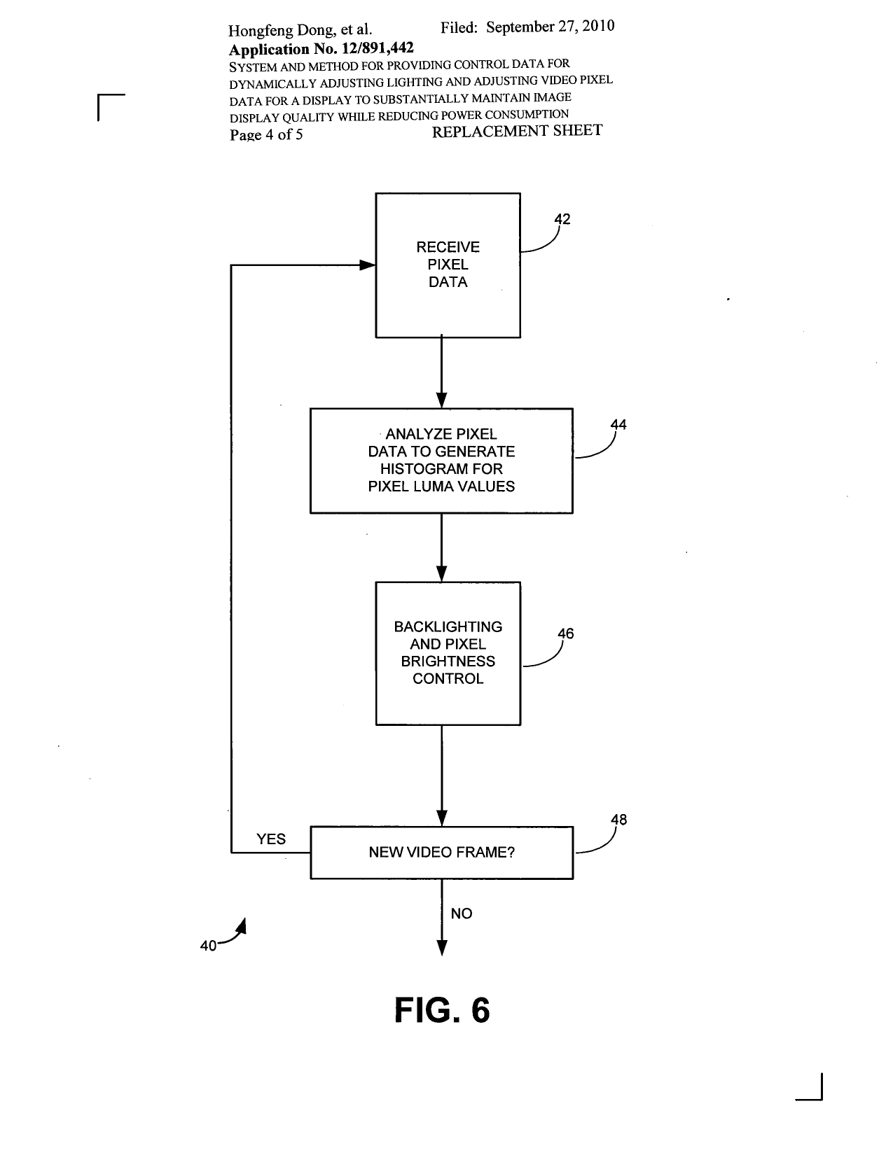

Referring to FIG. 6, in accordance with another embodiment, a method for dynamically adjusting backlighting and adjusting video pixel data can be represented generally as shown 40. First, incoming pixel data is received 42 and analyzed 44 to generate the histogram for the pixel luma values. Next, backlighting and pixel brightness are adjusted 46 (discussed in more detail below). Finally, it is determined whether a new video frame has been received 48. If so, this process is repeated.

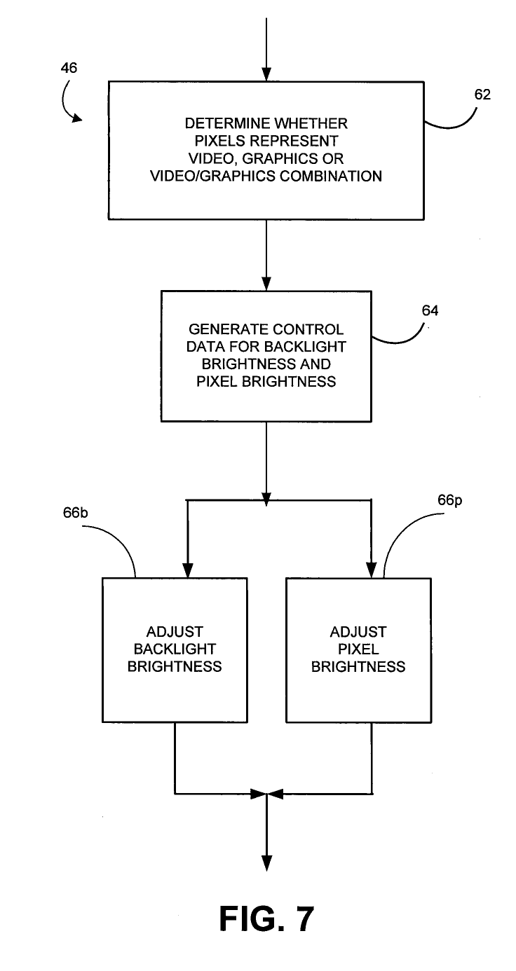

Referring to FIG. 7, in accordance with another embodiment, backlighting and pixel brightness adjustment 46 is performed by determining whether the incoming image pixels represent natural imagery, graphics, or a combination of natural imagery and graphics 62. Next, control data are generated 64 for adjusting the backlight brightness and pixel brightness based on this previous classification. Following this, the backlight brightness is adjusted 66b and the pixel brightness is adjusted 66p, with such steps 66b, 66p preferably being performed contemporaneously.

Based upon the foregoing discussion, it will be readily apparent to one of ordinary skill in the art that, in accordance with the embodiments described herein, the image statistics profile can be advantageously used to determine how the image is to be best treated for purposes of controlling or adjusting the light source, e.g., the backlight in the case of a display or the light source in the case of a projector.

Various other modifications and alternations in the structure and method of operation of this disclosed subject matter will be apparent to those skilled in the art without departing from the scope and the spirit. Although the disclosed subject matter has been described in connection with specific preferred embodiments, it should be understood that the disclosed subject matter as claimed should not be unduly limited to such specific embodiments. It is intended that the following claims define the scope and that structures and methods within the scope of these claims and their equivalents be covered thereby.

What is claimed is:

1. A method comprising:
determining whether a plurality of pixels represents one or more of a plurality of images which includes an image containing primarily natural imagery, an image containing primarily graphics imagery, and an image containing a combination of at least respective portions of natural and graphics imagery; and
generating control data for adjusting light source brightness for a display and adjusting said incoming pixel brightness for display on said display, wherein said light source brightness is adjusted and brightness of at least a portion of said plurality of pixels is increased in accordance with said one or more of a plurality of images primarily represented by said plurality of pixels.

2. The method of claim 1, wherein said determining whether a plurality of pixels represents one or more of a plurality of images is based on data representing a plurality of pixel luma values corresponding to said plurality of pixels.

3. The method of claim 2, wherein said data representing a plurality of pixel luma values corresponding to said plurality of pixels comprises histogram data, and said determining whether a plurality of pixels represents one or more of a plurality of images based on said histogram data comprises computing one or more percentages of said plurality of pixels having one or more ones of said plurality of pixel luma values.

4. The method of claim 1, wherein said determining whether a plurality of pixels represents one or more of a plurality of images is based on a priori knowledge.

5. The method of claim 1, wherein said light source brightness is reduced by one of a plurality of percentages and brightness of at least a portion of said plurality of pixels is increased in accordance with one of a plurality of multiple-segment piecewise linear curves defined in accordance with respective segment slopes, thresholds, and threshold offsets.

6. The method of claim 5, wherein said plurality of multiple-segment piecewise linear curves comprises:
an N1-segment piecewise linear curve defined in accordance with N1 first segment slopes, N1−1 first thresholds, and N1−1 first threshold offsets when said incoming pixel data primarily represents a video image;
an N2-segment piecewise linear curve defined in accordance with N2 second segment slopes, N2−1 second thresholds, and N2−1 second threshold offsets when said incoming pixel data primarily represents a graphics image; and
an N3-segment piecewise linear curve defined in accordance with N3 third segment slopes, N3−1 third thresholds, and N3−1 third threshold offsets when said incoming pixel data represents a combination of video and graphics images.

7. The method of claim 1, wherein said generating control data for adjusting light source brightness for said display and adjusting said incoming pixel brightness for display on said display comprises generating said control data such that said light source brightness is reduced over a plurality of video frames.

8. The method of claim 1, wherein said generating control data for adjusting light source brightness for said display and adjusting said incoming pixel brightness for display on said display comprises generating said control data such that said light source brightness is reduced and said pixel luma values are increased contemporaneously.

9. The method of claim 1, further comprising adjusting said light source brightness and said pixel luma values in accordance with said control data.

10. An apparatus including circuitry, comprising:
adaptive contrast enhancement circuitry for
determining whether a plurality of pixels represents one or more of a plurality of images which includes an image containing primarily natural imagery, an image containing primarily graphics imagery, and an image containing a combination of at least respective portions of natural and graphics imagery, and
generating control data for adjusting light source brightness for a display and adjusting said incoming pixel brightness for display on said display, wherein said light source brightness is adjusted and brightness of at least a portion of said plurality of pixels is increased in accordance with said one or more of a plurality of images primarily represented by said plurality of pixels.

11. The apparatus of claim 10, wherein said determining whether a plurality of pixels represents one or more of a plurality of images is based on data representing a plurality of pixel luma values corresponding to said plurality of pixels.

12. The apparatus of claim 11, wherein said data representing a plurality of pixel luma values corresponding to said plurality of pixels comprises histogram data, and said determining whether a plurality of pixels represents one or more of a plurality of images based on said histogram data comprises computing one or more percentages of said plurality of pixels having one or more ones of said plurality of pixel luma values.

13. The apparatus of claim 10, wherein said determining whether a plurality of pixels represents one or more of a plurality of images is based on a priori knowledge.

14. The apparatus of claim 10, wherein said light source brightness is reduced by one of a plurality of percentages and brightness of at least a portion of said plurality of pixels is increased in accordance with one of a plurality of multiple-segment piecewise linear curves defined in accordance with respective segment slopes, thresholds, and threshold offsets.

15. The apparatus of claim 14, wherein said plurality of multiple-segment piecewise linear curves comprises:
an N1-segment piecewise linear curve defined in accordance with N1 first segment slopes, N1−1 first thresholds, and N1−1 first threshold offsets when said incoming pixel data primarily represents a video image;
an N2-segment piecewise linear curve defined in accordance with N2 second segment slopes, N2−1 second thresholds, and N2−1 second threshold offsets when said incoming pixel data primarily represents a graphics image; and
an N3-segment piecewise linear curve defined in accordance with N3 third segment slopes, N3−1 third thresholds, and N3−1 third threshold offsets when said incoming pixel data represents a combination of video and graphics images.

16. The apparatus of claim 11, wherein said adaptive contrast enhancement circuitry is for generating said control data such that said light source brightness is reduced over a plurality of video frames.

17. The apparatus of claim 11, wherein said adaptive contrast enhancement circuitry is for generating said control data such that said light source brightness is reduced and said pixel luma values are increased contemporaneously.

18. The apparatus of claim 11, further comprising pixel luma adjustment circuitry for adjusting said light source brightness and said pixel luma values in accordance with said control data.

19. An apparatus, comprising:
memory capable of storing executable instructions; and
at least a first processor operably coupled to said memory and responsive to said executable instructions by
determining whether a plurality of pixels represents one or more of a plurality of images which includes an image containing primarily natural imagery, an image containing primarily graphics imagery, and an image containing a combination of at least respective portions of natural and graphics imagery, and
generating control data for adjusting light source brightness for a display and adjusting said incoming pixel brightness for display on said display, wherein said light source brightness is adjusted and brightness of at least a portion of said plurality of pixels is increased in accordance with said one or more of a plurality of images primarily represented by said plurality of pixels.

20. The apparatus of claim 19, wherein said determining whether a plurality of pixels represents one or more of a plurality of images is based on data representing a plurality of pixel luma values corresponding to said plurality of pixels.

21. The apparatus of claim 20, wherein said data representing a plurality of pixel luma values corresponding to said plurality of pixels comprises histogram data, and said determining whether a plurality of pixels represents one or more of a plurality of images based on said histogram data comprises computing one or more percentages of said plurality of pixels having one or more ones of said plurality of pixel luma values.

22. The apparatus of claim 19, wherein said determining whether a plurality of pixels represents one or more of a plurality of images is based on a priori knowledge.

23. The apparatus of claim 19, wherein said light source brightness is reduced by one of a plurality of percentages and brightness of at least a portion of said plurality of pixels is increased in accordance with one of a plurality of multiple-segment piecewise linear curves defined in accordance with respective segment slopes, thresholds, and threshold offsets.

24. The apparatus of claim 23, wherein said plurality of multiple-segment piecewise linear curves comprises:
an N1-segment piecewise linear curve defined in accordance with N1 first segment slopes, N1−1 first thresholds, and N1−1 first threshold offsets when said incoming pixel data primarily represents a video image;
an N2-segment piecewise linear curve defined in accordance with N2 second segment slopes, N2−1 second thresholds, and N2−1 second threshold offsets when said incoming pixel data primarily represents a graphics image; and
an N3-segment piecewise linear curve defined in accordance with N3 third segment slopes, N3−1 third thresholds, and N3−1 third threshold offsets when said incoming pixel data represents a combination of video and graphics images.

25. The apparatus of claim 19, wherein said at least a first processor is responsive to said executable instructions by generating said control data such that said light source brightness is reduced over a plurality of video frames.

26. The apparatus of claim 19, wherein said at least a first processor is responsive to said executable instructions by generating said control data such that said light source brightness is reduced and said pixel luma values are increased contemporaneously.

27. The apparatus of claim 19, further comprising a pixel luma adjuster operably coupled to said at least a first processor and responsive to said control data by adjusting said light source brightness and said pixel luma values.
